(19) United States
(12) Patent Application Publication
(10) Pub. No.: US 2017/0000693 A1
(43) Pub. Date: Jan. 5, 2017

(54) MEDICATION DISPENSING SYSTEM

(71) Applicant: SCRIPTPRO LLC, MISSION, KS (US)

(72) Inventors: STACY ORR, MISSION, KS (US); MICHAEL BRAUN, MISSION, KS (US); CHARLES ROBERTS, III, MISSION, KS (US)

(73) Assignee: SCRIPTPRO LLC, MISSION, KS (US)

(21) Appl. No.: 15/194,010

(22) Filed: Jun. 27, 2016

Related U.S. Application Data
(60) Provisional application No. 62/292,704, filed on Feb. 8, 2016.
(60) Provisional application No. 62/186,833, filed on Jun. 30, 2015.

(51) Int. Cl. A61J 7/04

(52) U.S. Cl. CPC A61J 7/0418; A61J 7/0454; A61J 7/0481

(57) ABSTRACT

A medication dispensing system for use in a home, assisted living, nursing home, or other outpatient setting includes a dispensing apparatus and a control system. The dispensing apparatus is compact and portable and broadly comprises a cassette and a dispensing unit for receiving medication vials and selectively and automatically dispensing medications from the medication vials. The control system receives data regarding the medications to be received in the dispensing apparatus, instructs the dispensing apparatus to dispense the medications according to a medication regimen, monitors patient usage of the dispensing system, and alerts the patient and/or caregiver when medications are ready to be taken or that scheduled medications have not been taken. The medication dispensing system is configured for use with standard medication vials fitted with specially designed vial caps for interfacing with the dispensing unit so as to singulate and selectively retrieve the medications from the medication vials.

### RELATED APPLICATIONS

This patent application is a non-provisional regular utility patent application and claims priority benefit with regard to all common subject matter of U.S. Provisional Patent Application Ser. No. 62/186,833, filed on Jun. 30, 2015, and entitled HOME MEDICATION DISPENSING SYSTEM and U.S. Provisional Patent Application Ser. No. 62/292,704, filed on Feb. 8, 2016, and entitled HOME MEDICATION DISPENSING SYSTEM. The identified earlier-filed provisional patent applications are hereby incorporated by reference in their entirety into the present application.

### BACKGROUND

Medication regimens are often followed by patients in outpatient settings without the oversight of doctors, pharmacists, or caregivers and are often complex and/or confusing. For example, many patients must take several different medications at different times of the day and must remember when to start and stop taking each of the medications. Patients often forget to take their medications, take them when they shouldn't, and/or or mix them up such that they do not take the correct medication at the correct time. Medication organizers such as pillboxes and medication sheets help patients organize their medications and help them remember whether they have taken them. However, medication organizers do not alert patients to take their medications, notify them when they have not taken their medications, or prevent them from taking the wrong medications. Medication organizers can also be difficult to open and fill properly. Elderly, young, or mentally disabled patients often cannot understand and follow medication regimens or medication organizer instructions. Medication regimens also often change, and such changes are difficult to relay to patients without introducing further confusion such as which medications should be discontinued, which medications should be taken in reduced or increased quantities, and how to properly incorporate new medications into the regimen.

### SUMMARY

Embodiments of the invention solve the above-mentioned problems and provide a distinct advance in medication dispensing in outpatient settings. More particularly, the invention provides a medication dispensing system that organizes and dispenses a patient's medications without the need for the patient to actively follow a medication regimen or medication instructions. The medication dispensing system also ensures the patient takes the medications, and takes them at the right time. It can alert the patient, a caregiver, or another entity when the medications have not been taken properly.

An embodiment of the invention is a medication dispensing system that is specially configured for use in a home, assisted care facility, nursing home, or other outpatient setting and that receives, stores, and dispenses prescription and non-prescription pills, capsules, vitamins, and other medications (collectively referred to herein as “medications”) according to a prescribed medication regimen. The medication dispensing system broadly comprises a dispensing apparatus and a control system. The dispensing apparatus receives and stores a number of medication vials therein and selectively and automatically dispenses medications from the medication vials under the control of the control system. The control system receives data regarding the medications and instructs the dispensing apparatus to dispense the medications according to the medication regimen.

An embodiment of the dispensing apparatus broadly comprises a housing, a cassette, a dispensing unit, a receptacle, and a receptacle cover. The housing may be any shape and size and encloses the other components of the system within an interior chamber. The housing also includes a first opening for loading the medication vials into the cassette and a second opening for dispensing medications to a patient.

The cassette receives and retains the medication vials in the interior chamber of the housing and selectively shifts the medication vials to a dispensing position. The dispensing unit selectively retrieves medications from selected medication vials and dispenses the medications through the second opening of the housing. The receptacle is aligned with the second opening in the housing and receives the medications dispensed from the medication vials so they are available to the patient. The receptacle cover encloses the receptacle until all required units of all required medications of a predetermined grouping of medications have been dispensed so that the medications are taken at a proper time and/or in a proper order according to the medication regimen.

The control system receives medication data for the medications loaded in the dispensing apparatus and controls operation of the dispensing apparatus in response to the medication data and other information. An embodiment of the control system broadly comprises a data input unit, a memory, and a controller. The data input unit receives the medication data, which may include information for medication type, dosage, medication regimen, patient identification information, and patient health information. The data input unit may be any device capable of receiving or obtaining data such as a bar code reader, Quick Response (QR) code reader, image scanner, transceiver, data port, or a touch display or other user inputs. In one embodiment, the data input unit receives medication data from a pharmacy computer or healthcare provider server over the internet or another wireless communication network.

The memory stores the medication data and other data used for operation of the medication dispensing system. The controller selects a medication vial containing a medication to be dispensed according to the medication regimen, identifies the position of the selected medication vial, instructs the cassette to shift the selected medication vial to the dispensing position, and instructs the dispensing unit to retrieve the medication from the selected medication vial and dispense the medication to the receptacle. The controller may also shift the receptacle cover to an open position after all medications of a predetermined medication grouping have been dispensed and may shift the receptacle cover to a closed position and begin dispensing additional medications after all medications of a previous medication grouping have been removed from the receptacle.

Some embodiments of the dispensing apparatus may also include sensors for sensing whether the patient has taken medications, alarms or indicators for alerting the patient that medications are ready to be taken or that medications have not been taken, and cameras for monitoring the patient to ensure that the patient takes the medications. For example, one embodiment of the dispensing apparatus includes a receptacle sensor for sensing whether medications dispensed to the receptacle have been removed after a predetermined period of time, an alarm that beeps or otherwise indicates if the medications have not been removed, and a forward facing camera for capturing video of the patient after the patient removes the medications.

Embodiments of the above-described medication dispensing system are especially configured for use with medication vials constructed in accordance with other embodiments of the invention. The vials are fitted with vial caps that assist the dispensing apparatus in selectively retrieving medications from the vials. Each vial cap comprises a variable diameter plug for attaching the vial cap to vials of different sizes and a medication separator for retrieving one unit of medication from the vials at a time. For example, the medication separator may singulate the medications when subjected to an oscillating driving waveform generated by the dispensing unit. This ensures that the correct amount of medication is retrieved from the medication vials.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a medication dispensing system constructed in accordance with an embodiment of the invention;

FIG. 2 is a perspective view of a medication vial and vial cap for use with the medication dispensing system of FIG. 1;

FIG. 3 is an exploded view of the medication vial and vial cap of FIG. 2;

FIG. 4 is a perspective view of a cassette and dispensing unit assembly of a dispensing apparatus of the medication dispensing system of FIG. 1;

FIG. 5 is an enlarged view of the dispensing unit of FIG. 4;

FIG. 6 is a block diagram of selected electronic components of the medication dispensing system of FIG. 1;

FIG. 7 is a flow diagram of steps in a method of operating the medication dispensing system of FIG. 1; and

FIG. 8 is a flow diagram of steps in a method of dispensing medication via the medication dispensing system of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

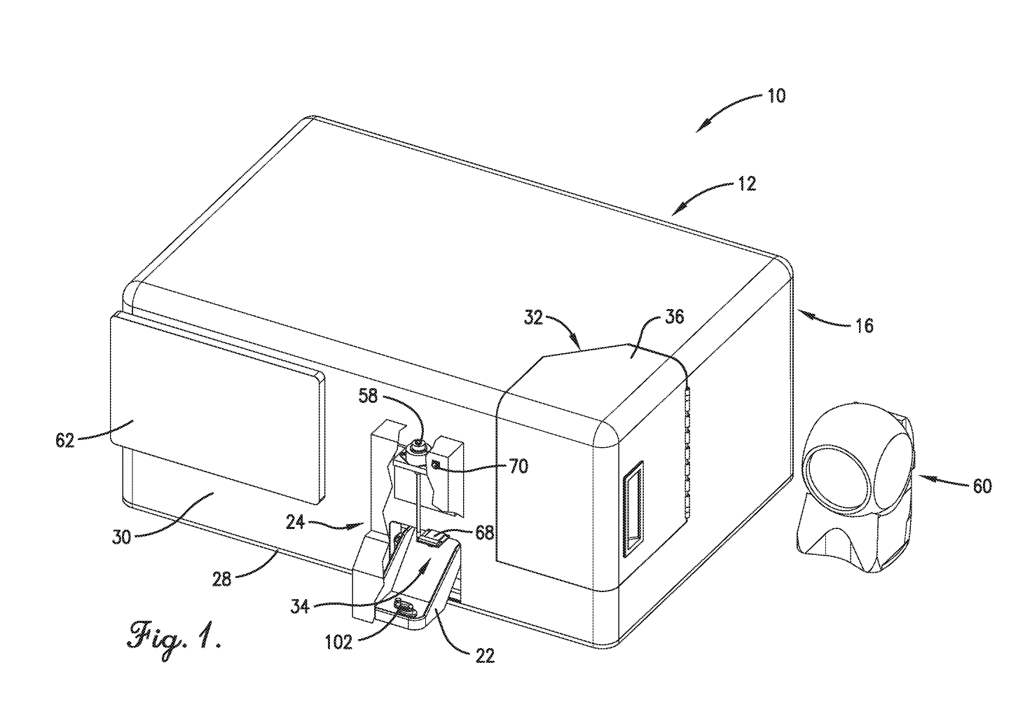

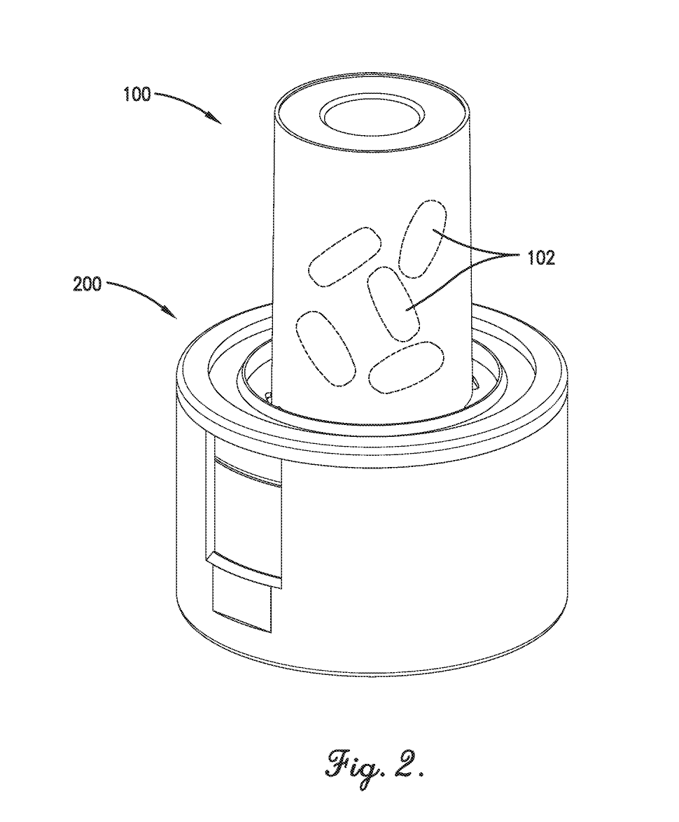

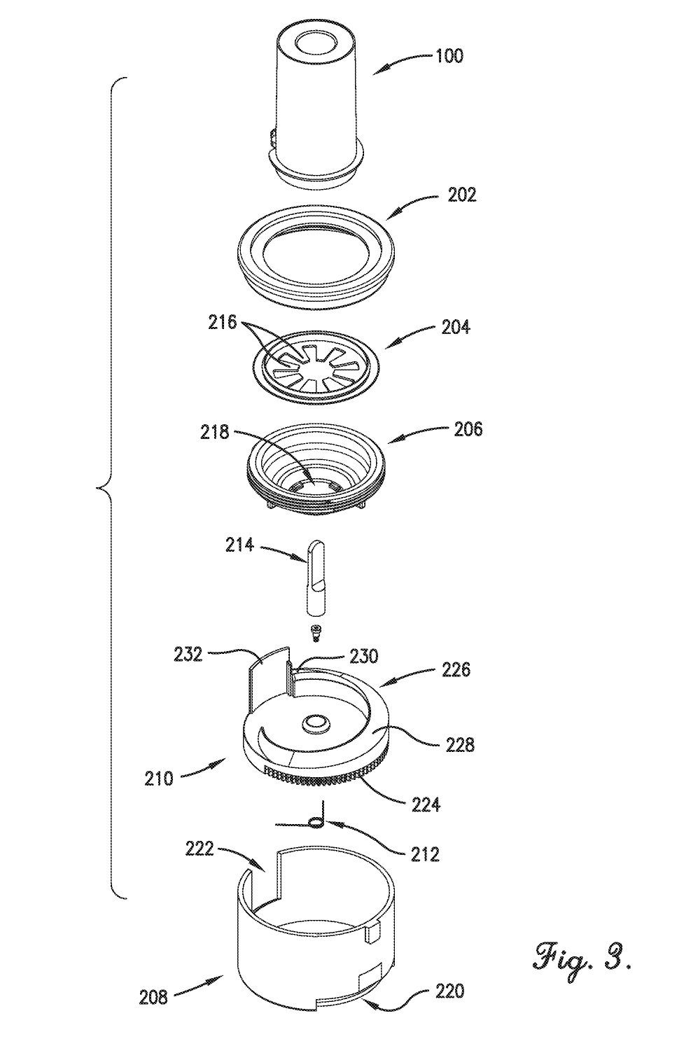

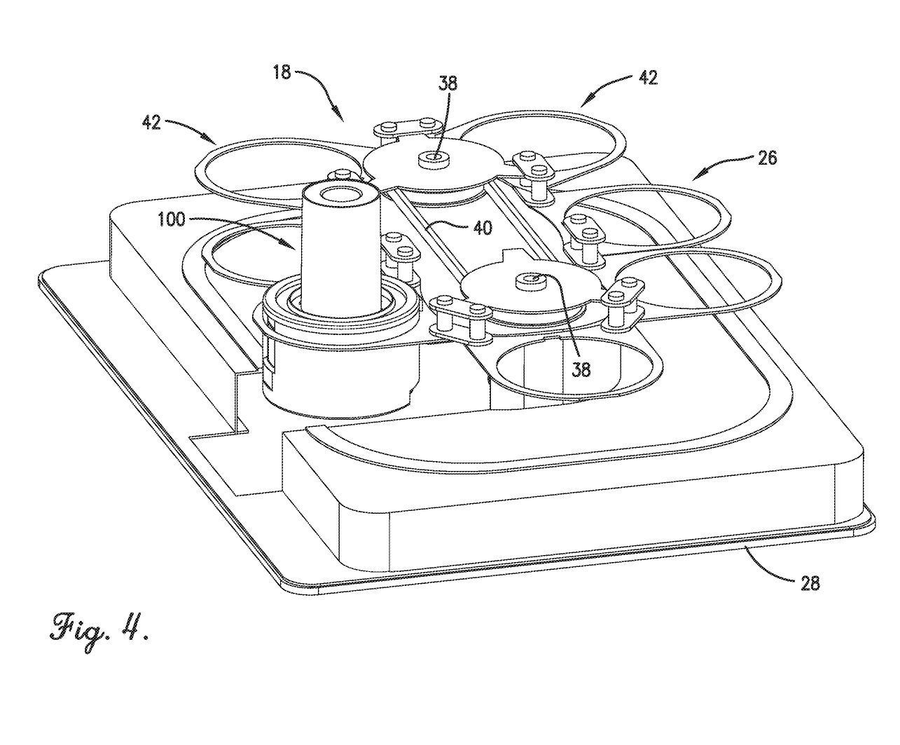

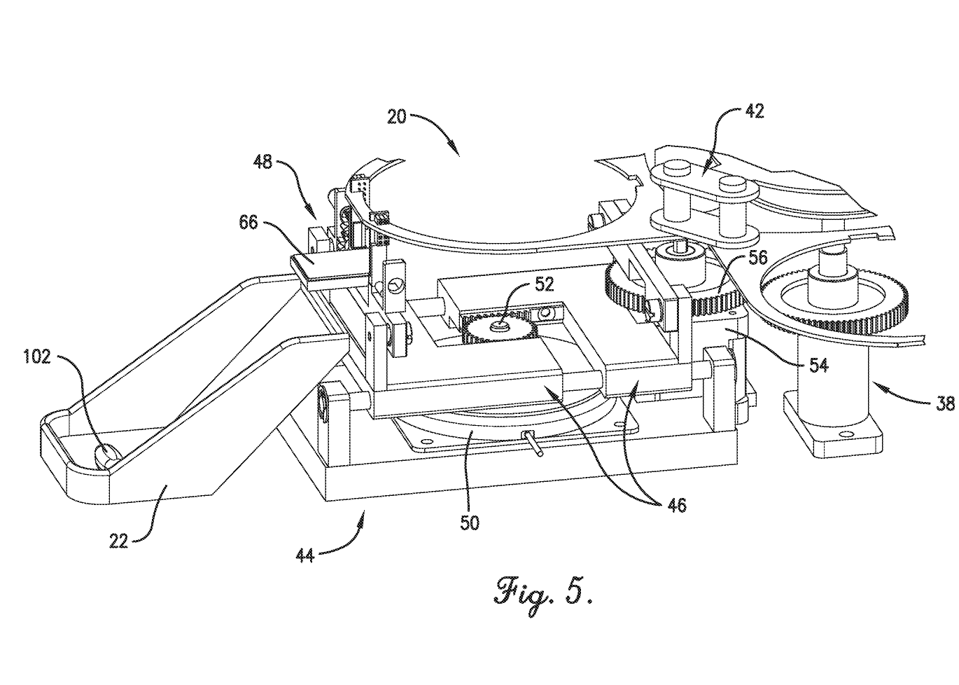

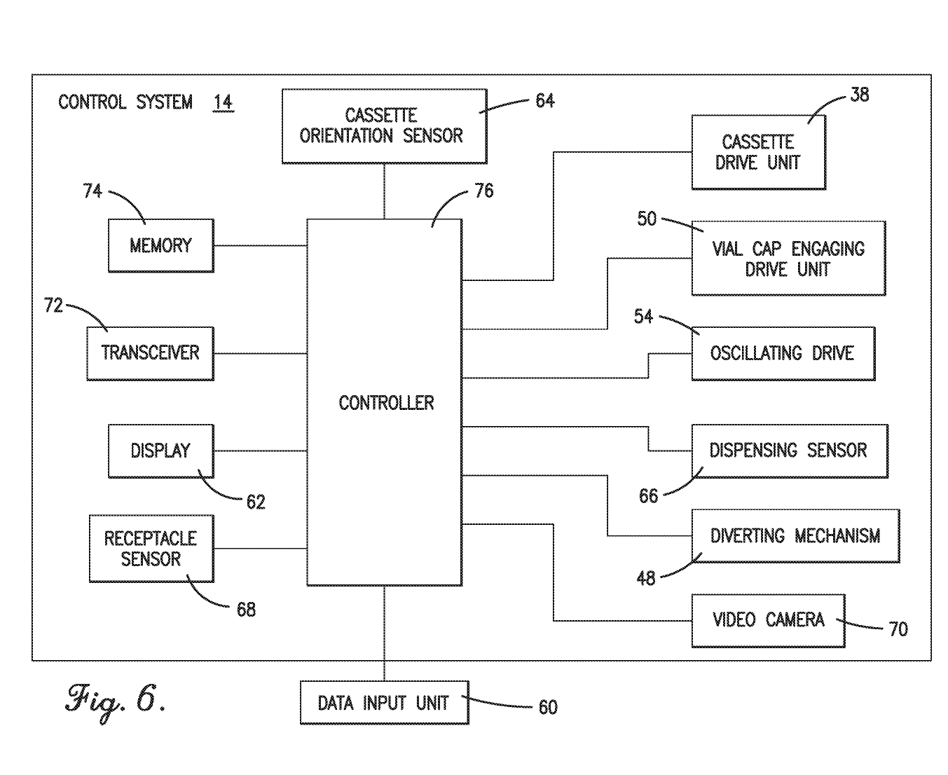

Turning to FIGS. 1-6, a medication dispensing system 10 constructed in accordance with an embodiment of the invention is illustrated. The medication dispensing system 10 is especially configured for personal or individual use in a home, assisted care facility, nursing home, or other outpatient setting for receiving, storing, and dispensing prescription and non-prescription pills, capsules, vitamins, and other medications according to a medication regimen. The medication dispensing system 10 selectively dispenses medications from medication vials 100 having vial caps 200 attached thereto (best shown in FIGS. 2 and 3). Embodiments of the medication dispensing system 10 may also monitor patient usage for ensuring that the patient takes the medications and/or alerting the patient, a caregiver, or another entity when the medications have not been taken.

Embodiments of the medication vials 100 and vial caps 200 will first be described in detail with reference to FIGS. 2 and 3. The medication vials 100 each retain medications 102 and may be cylindrical pill bottles or other similar medication containers or receptacles. The medication vials 100 may be of any shape and size such as between 6 dram and 64 dram (between approximately 1 inch in diameter to 3 inches in diameter). The medications 102 may be painkillers, antibiotics, nutrition supplements, hormone pills, birth control, steroids, insulin, statins, placebos, or any other prescription or non-prescription pills, capsules, or tablets. The medication vials 100 or packaging or documentation associated with the medication vials 100 may be labeled or marked with medication data corresponding to the medications in the medication vials 100. The medication data may indicate the medication type, medication count, dosage, a medication regimen, patient identification, patient health information, and any other suitable information. The medication data may also be displayed on or with the medication vials 100 in human readable text or images.

The vial caps 200 allow a medication to be selectively and automatically dispensed from the medication vials 100 via the medication dispensing system 10. An embodiment of a vial cap 200 is best shown in FIG. 3 and may comprise a rim 202, a flexible flange 204, a funnel lid 206, a retainer 208, a medication separator 210, a biasing element 212, and an agitator 214.

The rim 202 secures the flexible flange 204 to the funnel lid 206. The flexible flange 204 may be a conformable gasket having radially inwardly-extending flaps 216 or other variable diameter plug configured to frictionally or adjustably engage the medication vial 100. The funnel lid 206 may be a concave, tapered, or bowl-shaped attachment having a small central opening 218 for channeling medication towards a center of the medication separator 210. The retainer 208 engages a vial carriage of the cassette 18 and includes a gear opening 220 through which the medication separator 210 is engaged and a medication opening 222 through which medications 102 pass.

The medication separator 210 singulates medications 102 for preparing the medications 102 to pass through the medication opening 222 one at a time and may be a helical separator, tapered screw separator, or other singulating mechanism. For example, the medication separator 210 may include a separator gear 224, a helical ramp 226 having a slanted section 228 and a horizontal section 230 and a gate 232. The separator gear 224 is engaged by the oscillating gear 56 for turning the medication separator 210. The slanted section 228 coils upwards along the inside of an outer wall of the retainer 208 and the horizontal section 230 extends from the slanted section 228 to the medication opening 222. The gate 232 may be reversibly shifted to a closed position in front of the medication opening 222 for preventing additional medications 102 from passing therethrough. To that end, the biasing element 212 urges the gate 232 to the closed position when the medication separator is not being engaged or acted upon by the oscillating gear 56 and may be a torsion spring or any other suitable biasing component. The agitator 214 extends into the medication vial 100 and helps stir or dislodge the medications 102 as the vial cap 200 is engaged and may be a flattened protrusion, baffle, or other similar member.

Embodiments of the medication dispensing system 10 will now be described in detail with reference to FIGS. 1 and 4-6. One embodiment of the medication dispensing system 10 broadly comprises a dispensing apparatus 12 and a control system 14. The medication dispensing system 10 may be combined or in communication with, interface with, and/or include additional dispensing apparatuses, control systems, and/or other local or remote computing devices.

The dispensing apparatus 12 broadly comprises a housing 16, a cassette 18, a dispensing unit 20, a receptacle 22, and a receptacle cover 24. The dispensing apparatus 12 may be replaceable and/or interchangeable with other dispensing apparatuses. For example, the dispensing apparatus 12 may be returned to a pharmacy or clinic in exchange for a similar dispensing apparatus.

The housing 16 may be any suitable shape and size and encloses the other components of the medication dispensing system 10 within an interior chamber 26. In particular, the housing 16 may be lightweight, compact, ergonomical, portable, and/or easily accessible for use in home, outpatient, travel, and/or temporary settings. The housing 16 may comprise a base 28 and an upper shell 30 having a first opening 32 and a second opening 34. The first opening 32 allows the medication vials 100 to be loaded into the cassette 18 in the interior chamber 26. A cover 36 may be retractably or removably positioned over the first opening 32 for securing the medication vials 100 in the interior chamber 26. A safety mechanism such as a lock or child-proof latch may retain the cover 36 in a closed position when the dispensing apparatus 12 is not in use or is dispensing the medications 102 for safeguarding the medications 102 in the dispensing apparatus 12. The second opening 34 allows the medications 102 to be dispensed into the receptacle 22 and may be the same or separate from the first opening 32.

The cassette 18 shifts a selected medication vial 100 to and from the dispensing unit 20 and broadly comprises a cassette drive unit 38, a cassette drive train 40, and a plurality of vial carriages 42. The cassette drive unit 38 may be a motor, servo, actuator, or any other suitable driving mechanism. The cassette drive train 40 transfers power from the cassette drive unit 38 to the vial carriages 42 and may include gears, pulleys, belts, rack and pinion components, or any other suitable power transfer components. The vial carriages 42 receive the medication vials 100 and transfers them to the dispensing unit 20. The vial carriages 42 may be specifically shaped to engage or receive the vial caps 200 of the medication vials 100 such that the medication vials 100 each can be oriented for being engaged by the dispensing unit 20. The vial carriages 42 may be reversibly connectable for increasing or decreasing the number of vial carriages in the cassette 18.

The dispensing unit 20 retrieves medication from selected medication vials 100 and broadly comprises a vial cap engager mechanism 44, a medication retrieval mechanism 46, and a diverting mechanism 48. The vial cap engager mechanism 44 shifts the medication retrieval mechanism 46 into and out of engagement with a vial cap 200 of a selected medication vial 100 positioned in the dispensing unit 20 and may include an engager drive unit 50 and an engager drive train 52. The engager drive unit 50 may be a motor, servo, actuator, or any other suitable driving mechanism. The engager drive train 52 may be a rack and pinion mechanism configured to shift the medication retrieval mechanism 46 between engaging and non-engaging positions. The medication retrieval mechanism 46 retrieves medication from the selected medication vial 100 and may include an oscillating drive 54 and an oscillating gear 56. The oscillating drive 54 may be a motor, servo, or actuator configured to be activated by the controller 76 as described in more detail below. The oscillating gear 56 may be configured to engage the medication separator 210 of the vial cap 200 of the selected medication vial 100 so as to singulate medication in the selected medication vial 100 such that a single unit of medication 102 is retrieved at a time as described in more detail below. The diverting mechanism 48 urges single medications 102 retrieved from the selected medication vial 100 through the second opening 34 of the housing 16 towards the receptacle and urges multiple medications 102 retrieved from the selected medication vial 100 back into the selected medication vial 100 such that only single medications 102 are dispensed to the receptacle 22 at a time. The diverting mechanism 48 may be a drive motor, servo, actuator, or other suitable actuating mechanism configured to shift or tilt the sensing plate or other surface towards the receptacle 22 or the selected medication vial 100.

The receptacle 22 receives the medications 102 dispensed through the second opening 34 and may be a tray, cup, chute, or other receiving component connected to or extending from the housing 16. The receptacle 22 may also be configured to retain or support a disposable or reusable medicine cup for receiving the medications.

The receptacle cover 24 may be a guard, lid, or slat configured to be closed over the second opening 34 and the receptacle 22 when the medications 102 are not being dispensed through the second opening 34 or when the medications 102 are not ready to be removed from the receptacle 22. The receptacle cover 24 may include a receptacle cover actuator 58 for opening or retracting the receptacle cover 24 when the medications 102 are ready to be removed from the receptacle 22 as described in more detail below. The receptacle cover actuator 58 may be a linear actuator, pivoting actuator, motor, servo, or any other suitable actuating mechanism. A safety system such as a lock, or child-proof mechanism may be configured to retain the receptacle cover 24 in a closed position when the dispensing apparatus 12 is not in use or is dispensing the medications 102 for safeguarding the medications 102 in the receptacle 22.

The control system 14 controls operation of the dispensing apparatus 12 in accordance with the medication data and broadly comprises a data input unit 60, a display unit 62, a cassette orientation sensor 64, a dispensing sensor 66, a receptacle sensor 68, a video camera 70, a transceiver 72, a memory 74, and a controller 76. The control system 14 may be integrated with the dispensing apparatus 12 or may be in the form of a smartphone, PDA, tablet, laptop, desktop computer, or any other computing device in communication with the dispensing apparatus 12.

The data input unit 60 may be a bar code reader, quick response (QR) code reader, light sensor, camera, plurality of user inputs, data bus, data port, transceiver, display and graphical user interface, or any other suitable mechanism for obtaining medication data. To that end, the data input unit 60 may detect, sense, or receive computer-readable data displayed on the medication vials 100 in the form of a bar code, QR code, printed text, or other image, entered or selected by the user, or transmitted to the medication dispensing system 10. The data input unit 60 may be connected to the dispensing apparatus 12, integrated with the dispensing apparatus 12, or in wireless communication with the dispensing apparatus 12 (as shown in FIG. 1).

The display unit 62 presents medication data, medication dispensing system information, patient information, visual alerts, usage reports, instructions, and/or other information via a graphical user interface (GUI). The display unit 62 may also include image windows, data spreadsheets, virtual setup windows, and virtual inputs. The display unit 62 may be integrated with the data input unit 60 described above or may be in the form of a smartphone, PDA, tablet, laptop, desktop computer, or any other computing device in communication with the dispensing apparatus 12.

The cassette orientation sensor 64 identifies the orientation of the cassette 18 and hence the position of each medication vial 100. The cassette orientation sensor 64 may detect markers on the cassette 18 corresponding to the cassette's orientation or alternatively may maintain a count of cassette orientation changes. The cassette 18 may alternatively be a rotatable turntable, conveyor system, or stationary storage cartridge configured to be accessed via a movable retrieval mechanism. The cassette 18 may be vertically or horizontally oriented and may be stackable and accessible from multiple sides.

The dispensing sensor 66 senses the presence of one or more medications retrieved from the selected medication vial 100 for determining whether the medication was singulated properly and is preferably an optical sensor. The dispensing sensor 66 may instead be a sensing plate or other weight sensor, capacitive sensor, proximity sensor, camera, or any other suitable sensor. The dispensing sensor 66 may be integrated with or embedded in an upper portion of the dispensing unit 20.

The receptacle sensor 68 senses whether the dispensed medication has been removed from the receptacle 22 and is preferably an optical sensor directed towards the receptacle 22. The receptacle sensor 68 may instead be a weight sensor, capacitive sensor, proximity sensor, camera, or any other suitable sensor. The receptacle sensor 68 may also sense whether medications have been dispensed to the receptacle 22. The receptacle sensor 68 may be integrated with or embedded in the receptacle 22 or the receptacle cover 24.

The video camera 70 captures video of the patient removing the medication from the receptacle 22 and/or consuming the dispensed medication for verifying whether the patient consumes the dispensed medication after the dispensed medication has been removed from the receptacle. The video camera 70 may be a webcam or other camera and may be integrated with, connected to, or in wireless communication with the dispensing apparatus 12. It will be understood that the video camera 70 is optional and may be integrated with the data input unit 60 described above.

The transceiver 72 transmits and receives data between the dispensing apparatus 12, the data input unit 60, and/or other electronic devices over a wireless communication network such as a cellular network, wifi network, or other network. For example, the transceiver 72 may transmit a report indicating whether the patient is taking prescribed medication to a mobile computing device of a caregiver or a healthcare provider. It will be understood that the transceiver 72 may be integrated with the data input unit 60 described above.

The memory 74 stores medication data, medication dispensing system information, patient information (e.g., patient identification and health information), and medication dispensing system usage thereon and may be any computer-readable non-transitory medium that can store programs for use by or in connection with an instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The controller 76 controls management of the medication vials 100, medication data, and patient information, and initiates medication dispensing, as described in more detail below. The controller 76 may also receive inputs from the patient via the data input unit 60 and/or display unit 62 and may communicate with other electronic devices via the transceiver 72. The controller 76 may include one or more circuit boards, memories, displays, inputs, and/or other electronic components.

The controller 76 may implement aspects of the present invention with one or more computer programs stored in or on computer-readable medium residing on or accessible by the processor. Each computer program preferably comprises an ordered listing of executable instructions for implementing logical functions in the controller 76. Each computer program can be embodied in any non-transitory computer-readable medium, such as the memory 74, for use by or in connection with the instruction execution system, apparatus, or device, such as a computer-based system, processor-containing system, or other system that can fetch the instructions from the instruction execution system, apparatus, or device, and execute the instructions.

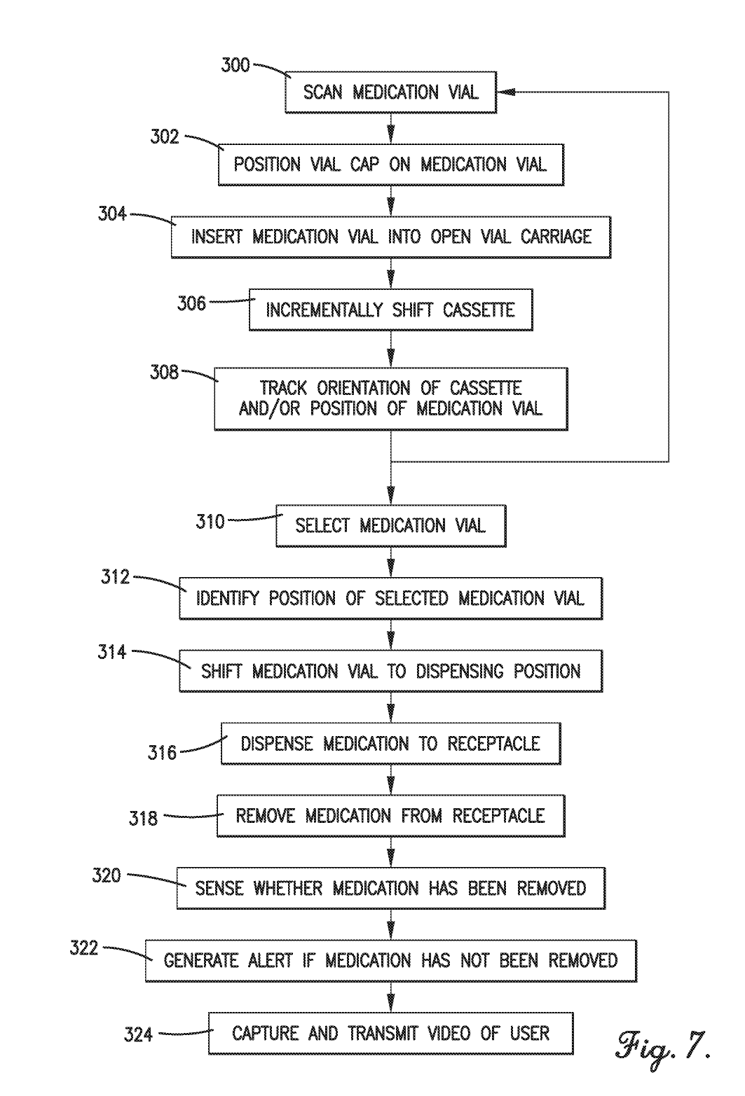

Use of the medication dispensing system 10 will now be described in more detail. First, a medication vial 100 may be scanned via the data input unit 60 so as to receive data representative of medication data therefrom such that a medication type of the medication in the medication vial 100 is identified, as shown in block 300 of FIG. 7. Other data pertaining to the medication such as medication count, dosage, medication regimen, and instructions may also be scanned. The medication vial 100 may instead be scanned automatically when or after being loaded into the cassette 18. Alternatively, the medication data may be loaded onto or transmitted to the medication dispensing system 10 or entered or selected via user inputs or the graphical user interface of the display unit 62.

The medication vial 100 may then be inserted into a vial cap 200, as shown in block 302. An original vial lid may need to be removed prior to placing the vial cap 200 on the medication vial 100. The flexible flange 204 may allow for the medication vial 100 to be inserted imperfectly into the vial cap 200.

The medication vial 100 may then be inserted through the first opening 32 of the housing 16 into a vacant vial carriage 42 of the cassette 18, as shown in block 304. Which vial carriage 42 the medication vial 100 is inserted into is not important so long as the vial carriage 42 is vacant.

The controller 76 may instruct the cassette drive unit 38 to incrementally shift the cassette 18 after the medication vial 100 is loaded, as shown in block 306. The controller 76 may detect or track the orientation of the cassette 18 after each incremental shift via the cassette orientation sensor 64 so as to track the position of each medication vial 100, as shown in block 308. Alternatively, the controller 76 may store which vial carriage 42 retains each medication vial 100 in the memory 74 and track the location of each vial carriage 42.

Blocks 300-308 may be repeated for additional medication vials 100, as shown in FIG. 7. That is, additional medication vials 100 may be scanned, capped, and inserted into open vial carriages 42 until all medication vials 100 are received in the cassette 18.

The controller 76 may then select a medication vial 100 containing medication to be dispensed at a particular time according to a medication regimen, as shown in block 310. For example, the controller 76 may select a medication vial 100 containing a painkiller scheduled to be ingested at noon. The controller 76 may access data from the memory 74 or may communicate with other electronic devices via the transceiver 72 to make this selection.

The controller 76 may then identify a position of the selected medication vial 100 in the cassette 18 according to the orientation of the cassette 18 and/or the position of the vial carriage 42 retaining the selected medication vial 100, as shown in block 312. Alternatively, the controller 76 may instruct the cassette drive unit 38 to cycle or reorient the cassette 18 until the selected medication vial 100 is identified.

The controller 76 may then instruct the cassette drive unit 38 to reorient the cassette 18 so as to shift the selected medication vial 100 to a dispensing position, as shown in block 314. That is, the cassette 18 may shift the selected medication vial 100 to the dispensing unit 20.

The controller 76 may then instruct the dispensing unit 20 to dispense medication from the selected medication vial 100 such that the medication of the selected medication vial 100 is received in the receptacle 22, as shown in block 316. Dispensing medications 102 via the dispensing unit 20 will be described in more detail below. The controller 76 may generate an alert and/or activate the receptacle cover actuator 58 so as to shift the receptacle cover 24 guarding or enclosing the receptacle 22 to an open position once all medications of a grouping of medications that are to be taken in the current instance according to the medication regimen have been dispensed to the receptacle 22. The controller 76 may also shift the receptacle cover 24 to a closed position and begin dispensing additional medications after all medications of a previous medication grouping have been removed from the receptacle 22. This ensures that medications 102 are taken at a proper time and in a proper order according to the medication regimen.

The dispensed medication may then be removed from the receptacle 22, as shown in block 318. The receptacle sensor 68 may sense whether the dispensed medication has been removed after a predetermined period of time, as shown in block 320. For example, the receptacle sensor 68 may sense that medication is still resting in the receptacle 22 or may sense that the receptacle 22 has not been accessed.

The controller 76 may generate an alert indicating that the dispensed medication has not been removed, as shown in block 322. The controller 76 may also instruct the display unit 62 to present the alert in visual form or may generate an audible alert via a speaker, ringer, or buzzer. The controller 76 may also generate a usage report indicating whether the patient has removed and/or taken the dispensed medication 102 and transmit the usage report to a caregiver or other remote entity over the wireless communication network.

The video camera 70 may then capture video of the patient ingesting or not ingesting the dispensed medication after the dispensed medication has been removed from the receptacle 22, as shown in block 324. The controller 76 may also transmit the video to a caregiver or other remote entity to alert the caregiver that the patient has not ingested the dispensed medication.

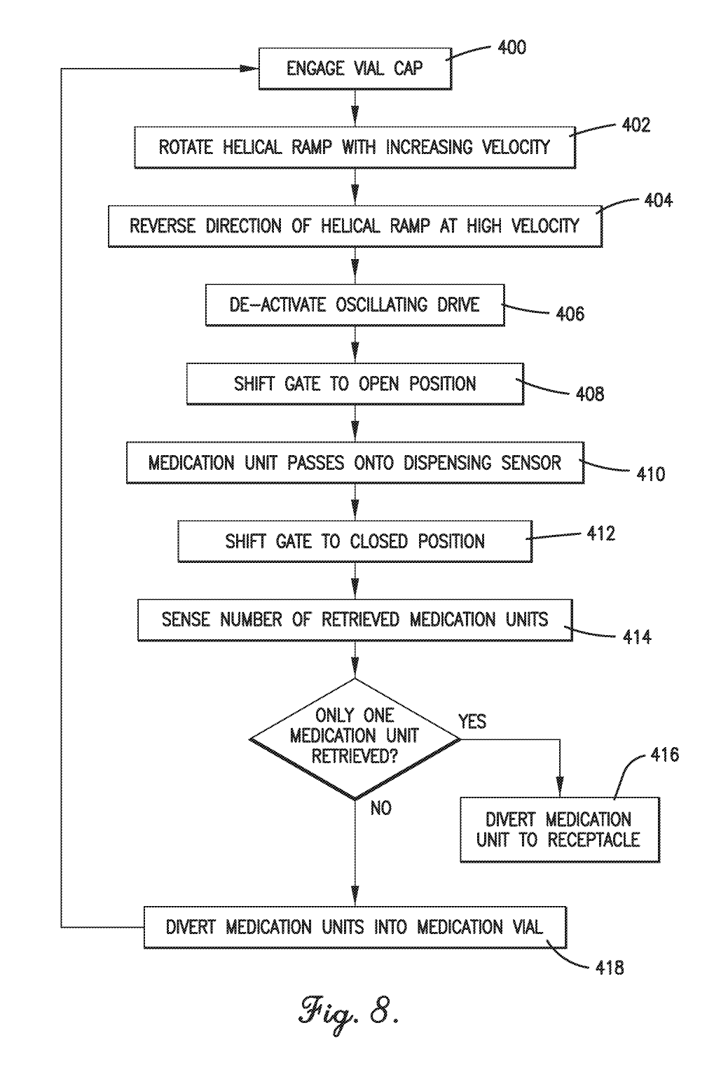

With reference to FIG. 8, dispensing medication will now be described in more detail. First, the oscillating drive 54 of the medication retrieval mechanism 46 may engage the medication separator 210 of the vial cap 200, as shown in block 400. That is, the engager drive unit 50 of the vial cap engager mechanism 44 may shift the medication retrieval mechanism 46 from a non-engaging position to an engaging position.

The controller 76 may then activate the oscillating drive 54 in a gradually increasing magnitude for a first period of time such that the medication separator 210 and hence the helical ramp 226 rotate with a gradually increasing rotational velocity in a first direction with the medications 102 resting on the helical ramp 226 of the medication separator 210, as shown in block 402. This prepares the medications 102 for being urged up the helical ramp 226.

The controller 76 may then activate the oscillating drive 54 in reverse in a high magnitude for a second period of time such that the medication separator 210 and hence the helical ramp 226 rotate at a high rotational velocity in a second direction opposite the first direction so that the medications 102 remain in a relatively fixed position, thus urging the medications 102 up the slanted section 228 of the helical ramp 226, as shown in block 404. This promotes singulation of the medications 102. The medications 102 may then rebound slightly down the slanted section 228 of the helical ramp 226 due to friction therebetween.

The controller 76 may then not activate or may deactivate the oscillating drive 54 for a third period of time to allow the medications 102 to reestablish static friction with the helical ramp 406, as shown in block 406. A medication 102 having reached the horizontal section 230 of the helical ramp 226 further singulates from other medications due to not rebounding at the end of the second period. This movement of gradually increasing rotational velocity, followed by high reverse rotational velocity, followed by zero velocity may be effected by a driving waveform having a frequency, magnitude, duration, shape, and/or power depending on the number of medications 102 in the medication vial 100 and the weight, size, shape, and/or surface friction coefficient of the medications 102.

The oscillating drive 54 may then shift the gate 232 of the medication separator 210 to an open position, as shown in block 408. A medication 102 reaching the horizontal section 230 of the helical ramp 226 may then pass through the medication opening 222 onto the dispensing sensor 66, as shown in block 410. The oscillating drive 54 may also shift the gate 232 to a closed position to prevent additional medications from passing through the retainer opening 222, as shown in block 412.

The dispensing sensor 66 may then sense whether only one medication 102 has been retrieved from the selected medication vial 100, as shown in block 414. For example, the dispensing sensor 66 may optically sense two medications being passed onto the dispensing sensor 66.

If only one medication 102 has been retrieved from the selected medication vial (as intended), the diverting mechanism 48 may then urge the single medication 102 through the second opening 34 of the housing towards or into the receptacle 22, as shown in block 416. If two or more medications 102 have been retrieved from the selected medication vial 100, the oscillating drive 54 may shift the gate 232 to an open position and the diverting mechanism 48 may urge the retrieved medications 102 back into the selected medication vial 100, as shown in block 418. Steps 400-418 may be then repeated until a single medication 102 has been retrieved from the selected medication vial 100 and dispensed to the receptacle 22.

The above-described medication dispensing system 10 provides many advantages over conventional medication dispensing systems. For example, the medication dispensing system 10 automatically and selectively dispenses medications according to a medication regimen or medication instructions. That is, the patient does not need to actively follow the medication regimen or medication instructions. Medication regimens can also easily be changed or updated without causing any confusion or uncertainty to the patient. This significantly reduces the changes of the patient taking the wrong medicine or not taking the correct amount of medicine. Medication vials 100 may be refilled, replaced, added, or removed from the medication dispensing system 10 at any time such that medications do not need to be manually reorganized or discarded when a medication regimen is altered or replaced. Medication vials can be received pre-fitted to vial caps or pre-loaded into the medication dispensing apparatus 12 so that the patient does not need to handle small pills or pill lids that are difficult to remove. Alerts may be generated to notify the patient that medications are ready to be removed from the receptacle 22 or that medications have not been removed from the receptacle 22. Other notifications, usage reports, images, and/or videos may be transmitted to a caregiver or other remote entity for allowing the patient's medication intake to be monitored remotely. Instructions and user inputs may also be presented on the display unit 62 for allowing the patient or caregiver to further operate the medication dispensing system 10.

The medication dispensing system 10 can also manage medication regimens and dispense medication for multiple patients. In this case, the display unit 62 may indicate which patient should take the dispensed medication. Alternatively, the dispensing unit 20 may dispense medications into separate receptacles for different patients. Furthermore, the upper shell 30 of the housing 16 may be removed from the base 28 for quickly removing multiple medication vials. Additional vial carriages and cassettes can also be added to or removed from the dispensing apparatus 12 for increasing the capacity of the medication dispensing apparatus 12.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A medication dispensing system comprising:
a dispensing apparatus comprising:
a housing for receiving medication vials containing medications; and
a dispensing unit positioned in the housing and configured to selectively retrieve the medications from the medication vials and dispense the medications from the housing; and
a control system comprising:
a data input unit for receiving data relating to the medications loaded in the dispensing apparatus, the data including a medication type;
a memory for storing the data; and
a controller configured to instruct the dispensing unit to dispense the medication from a selected medication vial according to a medication regimen.

2. The medication dispensing system of claim 1, wherein the dispensing unit is configured to dispense one unit of the medication from the selected medication vial at a time, the dispensing unit comprising a dispensing sensor configured to sense the presence of medication retrieved from the selected medication vial, the controller being further configured to determine whether more than one unit of the medication has been retrieved from the selected medication vial via the dispensing sensor and return the more than one medication to the selected medication vial.

3. The medication dispensing system of claim 1, wherein the dispensing apparatus further comprises a receptacle configured to receive the dispensed medications, the receptacle comprising a receptacle sensor for determining whether the dispensed medication has been removed from the receptacle.

4. The medication dispensing system of claim 3, further comprising a safety system configured to safeguard the medication in the medication vials and in the receptacle.

5. The medication dispensing system of claim 3, the controller being further configured to generate an alert for notifying a patient or a caregiver if the dispensed medication has not been removed from the receptacle.

6. The medication dispensing system of claim 3, further comprising a video camera for verifying whether the user consumes the dispensed medication after removing the dispensed medication from the receptacle.

7. The medication dispensing system of claim 1, wherein the controller is configured to select another medication vial containing an additional medication to be dispensed according to the medication regimen after the medication of the initially selected medication vial has been dispensed.

8. The medication dispensing system of claim 1, the dispensing apparatus further comprising a receptacle cover configured to be shifted to an open position when all medications of a predetermined grouping of medications have been dispensed to the receptacle, the controller being configured to generate an alert for notifying a patient or a caregiver that all medications of the predetermined grouping of medications have been dispensed to the receptacle and are ready for the patient to ingest.

9. The medication dispensing system of claim 1, further comprising a transceiver, the controller being further configured to receive the medication regimen from a pharmacy or other medical entity via the transceiver or via user inputs.

10. The medication dispensing system of claim 1, further comprising a display unit configured to display the medication regimen and/or data relating to operation of the medication dispensing system.

11. The medication dispensing system of claim 1, wherein the data input unit is a light-based scanner for scanning data displayed on the medication vials.

12. The medication dispensing system of claim 1, wherein the controller is further configured to generate documentation that the medication was dispensed and store the documentation on the memory.

13. The medication dispensing system of claim 1, wherein the dispensing unit comprises an oscillating drive gear configured to engage a medication separator of a vial cap of the selected medication vial for singulating medications in the selected medication vial such that a single medication is retrieved from the selected medication vial.

14. The medication dispensing system of claim 1, further comprising a cassette configured to selectively shift the medication vials to a dispensing position, the cassette further comprising a cassette orientation sensor, the controller being further configured to instruct the cassette to be reoriented based on a current orientation of the cassette and a current position of the selected medication vial.

15. The medication dispensing system of claim 14, wherein the medication dispensing system is configured to receive additional cassettes for accommodating large medication regimens.

16. The medication dispensing system of claim 14, wherein the cassette is configured to be replaced with cassettes of different sizes.

17. A medication dispensing system comprising:
a number of medication vials each having an open end for receiving and storing medications;
a number of vial caps for closing the open ends of the medication vials;
a dispensing apparatus for receiving the medication vials and selectively dispensing the medications, the dispensing apparatus comprising:
a housing forming an interior chamber and including a first opening for receiving the medication vials and a second opening for dispensing the medications;
a cassette positioned in the housing and configured to retain the medication vials, the cassette including a plurality of vial carriages for receiving medication vials via the vial caps and a drive unit configured to manipulate the cassette to a number of orientations for selectively shifting the vial carriages and hence the medication vials to a dispensing position;
a dispensing unit positioned in the housing and configured to selectively retrieve medications from the medication vials via the vial caps and dispense the medications through the second opening of the housing;
a receptacle configured to receive the dispensed medications from the dispensing unit; and
a control system for controlling operation of the dispensing apparatus, the control system comprising:
a data input unit for identifying data relating to the medications, the data including a medication type;
a memory for storing the data; and
a controller configured to:
select a medication vial containing a medication to be dispensed according to a medication regimen, the vial selection being based on the data;
identify a position of the selected medication vial;
instruct the drive unit to reorient the cassette so as to shift the selected medication vial to the dispensing position; and
instruct the dispensing unit to dispense the medication from the selected medication vial such that the medication of the selected medication vial is received in the receptacle.

18. The medication dispensing system of claim 17, wherein the vial caps comprise a helical separator configured to be activated via the dispensing unit for retrieving one unit of the medication from the selected medication vial at a time.

19. The medication dispensing system of claim 17, wherein each vial cap comprises a variable diameter plug for receiving medication vials of different diameters.

20. A medication dispensing system comprising:
a number of medication vials each having an open end for receiving and storing medications;
a number of vial caps configured to be removably secured onto the medication vials, the vial caps each comprising a helical separator for delivering one unit of medication from the medication vials at a time;
a dispensing apparatus for receiving the medication vials and selectively dispensing the medications, the dispensing apparatus comprising:
a housing forming an interior chamber and including a first opening for allowing a user to load the medication vials into the medication dispensing system and a second opening for dispensing the medications, the housing including a cover configured to be closed over the first opening;
a cassette positioned in the housing and configured to retain the medication vials in the interior chamber of the housing, the cassette including a plurality of vial carriages for receiving the medication vials therein via the vial caps and a drive unit configured to manipulate the cassette to a number of orientations for selectively shifting the vial carriages and hence the medication vials to a dispensing position;
a cassette orientation sensor for sensing positions of the medication vials in the cassette;
a dispensing unit positioned in the housing and configured to engage a helical separator of one of the vial caps in the dispensing position for selectively retrieving medications from the medication vials and dispense the medications through the second opening of the housing; and
a receptacle configured to receive the medications from the dispensing unit; and
a control system for controlling operation of the dispensing apparatus, the control system comprising:
a barcode scanner for identifying data relating to the medications in the form of a barcode, the data including a medication type;
a transceiver for receiving operating instructions from a mobile device or other computing device of a user;
a display unit for displaying a medication regimen and/or data relating to operation of the medication dispensing system;
a memory for storing the data; and
a controller configured to:
select a medication vial containing a medication to be dispensed according to the medication regimen, the vial selection being based on the data obtained via the barcode scanner;
identify a position of the selected medication vial;
instruct the drive unit to reorient the cassette so as to shift the selected medication vial to the dispensing position; and
instruct the dispensing unit to dispense the medication from the selected medication vial such that the medication of the selected medication vial is received in the receptacle;
a receptacle sensor for determining whether the dispensed medication has been removed from the receptacle; and
a video camera for verifying whether the user consumes the dispensed medication after removing the dispensed medication from the receptacle.

21. A method of using a personal medication dispensing system in an outpatient setting, the method comprising the steps of:
inserting medication vials containing medications into a portable medication dispensing apparatus; and
removing dispensed medications from the portable medication dispensing apparatus, the dispensed medications being selectively retrieved from the medication vials via a dispensing unit under control of a control system according to a medication regimen.

22. The method of claim 21, further comprising the step of inputting data relating to the medications onto a memory of the control system of the personal medication dispensing system, the data including the medication regimen and a medication type.

23. The method of claim 22, wherein the step of inputting the data includes scanning machine-readable labels on the medication vials via a barcode scanner of the personal medication dispensing system.

24. The method of claim 22, wherein the step of inputting the data includes entering the data via a display unit of the personal medication dispensing system.

25. The method of claim 21, further comprising the steps of inserting additional medication vials containing additional medications into the medication dispensing apparatus and not removing medication vials having already been inserted into the medication dispensing apparatus when changes to the medication regimen have been made.

26. A medication vial for receiving medications and selectively dispensing the medications when acted upon by a medication dispensing system, the medication vial comprising:
a receptacle having an open end for receiving and storing the medications; and
a cap for closing the open end of the receptacle, the cap comprising:
a variable diameter plug for fitting the cap onto receptacles of different sizes;
a retainer configured to receive the open end of the receptacle and being configured to be received in a cassette of the medication dispensing system, the retainer including an opening for allowing the medications to pass therethrough; and
a medication separator configured to singulate the medications such that one medication passes through the opening of the retainer at a time.

27. The medication vial of claim 26, wherein the variable diameter plug is a flexible flange having radially inwardly-extending flaps for frictionally engaging the open-ended receptacle.

28. The medication vial of claim 26, wherein the medication separator is a helical separator.

29. The medication separator of claim 28, wherein the helical separator includes a helical ramp having a slanted section and a horizontally extending section, the helical separator being configured to singulate the medications up the slanted section to the horizontally extending section and further singulate the medications on the horizontally extending section.

30. The medication vial of claim 28, wherein the medication separator includes a gate configured to be reversibly shifted in front of the opening of the retainer for preventing additional medications from passing therethrough and further shifted to return medications to the medication vial.

31. The medication vial of claim 26, further comprising an agitator for stirring the medications.

32. The medication vial of claim 26, wherein the medication separator is configured to singulate the medications when rotated in a first direction at an increasing rotational velocity for a first period of time, rotated in a second direction opposite the first direction at a high rotational velocity for a second period of time, and not rotated for a third period of time.

33. The medication vial of claim 26, wherein the singulation is effected by a driving waveform having a frequency, magnitude, duration, shape, and/or power depending on the number of medications in the medication vial and the weight, size, shape, and/or surface friction coefficient of the medications.
